(19) United States
(12) Patent Application Publication
(10) Pub. No.: US 2014/0136581 A1
(43) Pub. Date: May 15, 2014

(54) STORAGE SYSTEM AND CONTROL METHOD FOR STORAGE SYSTEM

(71) Applicant: HITACHI, LTD., Tokyo (JP)

(72) Inventors: Yasuhiko Yamaguchi, Ninomiya (JP); Kazuki Hongo, Odawara (JP); Youichi Gotoh, Yokohama (JP)

(73) Assignee: HITACHI, LTD., Tokyo (JP)

(21) Appl. No.: 13/808,979

(22) PCT Filed: Nov. 15, 2012
(86) PCT No.: PCT/JP2012/007329

§ 371 Date: Jan. 8, 2013

(51) Int. Cl. G06F 17/30

(52) U.S. Cl. CPC G06F 17/30194
USPC 707/827

(57) ABSTRACT

In an example of the invention, a first storage subsystem includes a first router, a first processor, and a second processor. The first router receives a first write command and first write data for the first write command from a host. The first router transfers the first write command and the first write data to the second storage subsystem. Upon determination that a first processor cannot process the first write command because of a failure, the first router transfers the first write command to a second processor. The second processor performs processing to store the first write data to a first volume in accordance with the first write command.

### TECHNICAL FIELD

This invention relates to a storage system and a control method for a storage system.

### BACKGROUND ART

There is a known type of storage system that includes a plurality of storage subsystems configured as a cluster. This type of storage system associates real LDEVs of the storage subsystems with virtual LDEVs provided to host computers and configures the real LDEVs to have the identical data among the storage subsystems. When a host computer detects a failure in a storage subsystem, this configuration enables continuous processing of a command by reissuing the command to another storage subsystem.

For example, a storage system according to US 2011/0066801 A (PTL 1) creates virtual volumes based on a remote copy pair system and provides the virtual volumes to a host computer. A first storage subsystem and a second storage subsystem share a lock disk in a third storage subsystem.

The lock disk stores information for controlling the use of the virtual volumes. The virtual volumes are created based on the remote copy pair system to provide remote copy pairs each composed of a primary volume and a secondary volume. A user issues an instruction through a management server to create or delete a virtual volume and to create or delete a lock disk.

### CITATION LIST

### Patent Literature

PTL 1: US 2011/0066801 A

### SUMMARY OF INVENTION

### Technical Problem

In transferring a command among a plurality of storage subsystems in a clustered storage system, it is typical that a microprocessor (MP) in a storage subsystem connected to the host computer performs the transfer of the command. For this reason, overhead is generated by the command transfer among MPs and loads within the storage system are concentrated to the MPs.

In the meanwhile, if an MP in a typical clustered storage system develops a failure in the course of its processing a command, the information on the command gets lost. Accordingly, the storage system cannot return a response to the command to the host computer. For example, a switch path program in the host computer switches access paths after detection of a time-over. Consequently, it might take a long time until the host computer switches the access paths to resume the processing.

### Solution to Problem

An aspect of this invention is a storage system including a first storage subsystem providing a first volume and a second storage subsystem providing a second volume for storing copy data of data in the first volume. The first storage subsystem includes a first router, a first processor, and a second processor. The first router receives a first write command and first write data for the first write command from a host. The first router transfers the first write command and the first write data to the second storage subsystem. The second storage subsystem stores the first write data to the second volume in accordance with the first write command. The first processor is an active processor for processing the first write command. The second processor is a standby processor for processing the first write command. Upon determination that the first processor cannot process the first write command because of a failure, the first router transfers the first write command to the second processor. The second processor performs processing to store the first write data to the first volume in accordance with the first write command

### Advantageous Effects of Invention

An aspect of this invention achieves improvement in system performance in a storage system including a plurality of storage subsystems.

### BRIEF DESCRIPTION OF DRAWINGS

FIG. 1 is a block diagram schematically illustrating an exemplary computer system in an embodiment.

FIG. 2 is a diagram illustrating an overview of the operation of a storage system in the embodiment.

FIG. 3 illustrates an exemplary volume configuration in the storage system in the embodiment.

FIG. 4 illustrates an exemplary method of transferring frames and notices of completion thereto in the embodiment.

FIG. 5 illustrates an exemplary LUN management table in the embodiment.

FIG. 6 illustrates an exemplary virtual LDEV management table in the embodiment.

FIG. 7 illustrates an exemplary received frame management table in the embodiment.

FIG. 8 illustrates an exemplary transmitted frame management table in the embodiment.

FIG. 9 illustrates an exemplary MPPK assignment table in the embodiment.

FIG. 10 illustrates an exemplary received frame management table in the embodiment.

FIG. 11 illustrates an exemplary transmitted frame management table in the embodiment.

FIG. 12 illustrates an exemplary LUN management table in the embodiment.

FIG. 13 illustrates an exemplary virtual LDEV management table in the embodiment.

FIG. 14 illustrates an exemplary received frame management table in the embodiment.

FIG. 15 illustrates an exemplary transmitted frame management table in the embodiment.

FIG. 16 illustrates an exemplary MPPK assignment table in the embodiment.

FIG. 17 illustrates an exemplary standby MPPK assignment table in the embodiment.

FIG. 18 illustrates an exemplary standby MPPK assignment table in the embodiment.

FIG. 19 is a flowchart illustrating exemplary processing by a global router in the embodiment when it receives a frame.

FIG. 20 is a flowchart illustrating exemplary processing by the global router in the embodiment to transfer a write command.

FIG. 21 is a flowchart illustrating exemplary processing by the global router in the embodiment when it receives a response to a frame from another element in the storage system.

FIG. 22 is a flowchart illustrating exemplary processing by a local router in the embodiment.

FIG. 23 is a flowchart illustrating exemplary processing by a microprocessor in the embodiment.

### DESCRIPTION OF EMBODIMENTS

This invention relates to a technique to improve performance in a storage system. Hereinafter, an embodiment of this invention will be described with reference to the accompanying drawings. It should be noted that the embodiment is merely an example to realize this invention and is not to limit the technical scope of this invention. Throughout the drawings, the same elements are denoted by the same reference signs and different elements having the same configuration are denoted by the same reference signs; however, the latter may be denoted by different reference signs for the purpose of explanation.

A storage system in this embodiment includes a first storage subsystem and a second storage subsystem. The second storage subsystem provides a volume to store copy data of the data in a volume provided by the first storage subsystem.

When a router in the first storage subsystem receives a write command and write data from a host computer, it transfers the write command to a processor in the first storage subsystem, and further transfers the write command and the write data to the second storage subsystem. The configuration that the router at a foregoing stage to the processor performs the transfer to the second storage subsystem prevents load concentration to the processor and achieves low overhead in data transfer.

The first storage subsystem has a plurality of processors. When the router determines that the active processor assigned to a write command cannot process the write command because of its failure, it transfers the write command to another processor. This operation prevents a write command loss caused by the occurrence of the failure.

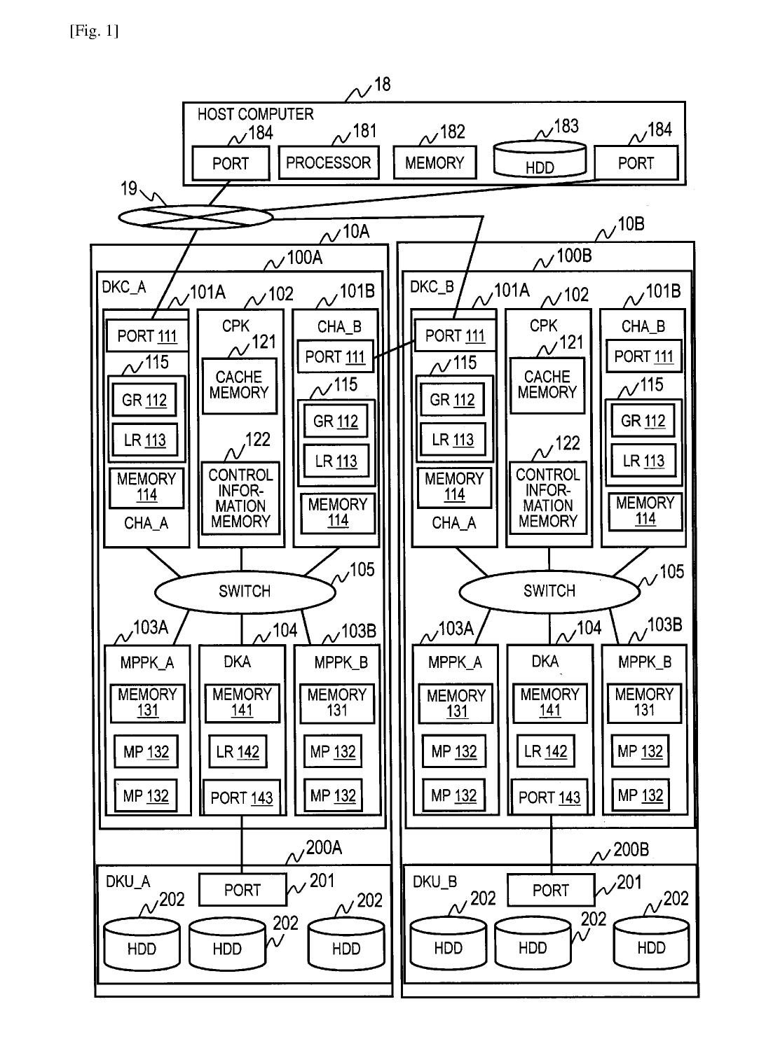

FIG. 1 illustrates an exemplary computer system in this embodiment, which includes a plurality of storage subsystems 10A and 10B, and a host computer 18 for processing and computing data. The computer system can include a plurality of host computers 18.

The storage subsystems 10A, 10B and the host computer 18 are interconnected via a data network 19. For example, the data network 19 is a storage area network (SAN). The data network 19 may be an IP network or any other kind of data communication network.

For example, the host computer 18 is a business server for running a business application program. The host computer 18 includes a processor 81, a memory 182 of a primary storage device, a hard disk drive (HDD) 183 of a secondary storage device, and ports 184.

The processor 181 invokes a program held in the memory 182 and operates in accordance with the program to perform a predetermined function of the host computer 18. The memory 182 stores a program executed by the processor 181 and information (data) required to execute the program. The program is loaded to the memory 182 from the HDD 183 or the network.

For example, the memory 182 holds an application program and a path management program. The processor issues an I/O request to the access target storage subsystem via the port 184. The path management program controls the access path for the I/O request.

For example, it is assumed that the storage subsystems 10A and 10B are configured as a cluster and one of them is active and the other is standby. The path management program issues commands to the active storage subsystem. When some failure occurs in the active storage subsystem, the path management program switches the access paths to issue commands to the standby storage subsystem.

The storage subsystem 10A includes a disk controller (DKC_A) 100A, which is a controller of the subsystem, and a disk unit (DKU_A) 200A, which is a unit composed of multiple storage drives. Likewise, the storage subsystem 10B includes a disk controller (DKC_B) 100B and a disk unit (DKU_B) 200B.

In the example of FIG. 1, the DKU_A 200A and the DKU_B 200B have the same configuration. For example, the DKU_A 200A communicates with the DKC_A 100A via a port 201. The DKU_A 200A includes a plurality of storage drives 202. In the example of FIG. 1, the storage drives 202 are HDDs having non-volatile magnetic disks. The storage drives 202 may be other kinds of drives, such as solid state drives (SSDs) including non-volatile semiconductor memories (such as flash memories).

The storage drives 202 store data (user data) transmitted from the host computer 18 via the DKC_A 100A. The plurality of storage drives 202 provide data redundancy using RAID computing to prevent data loss in the case of an occurrence of a failure in one of the storage drives 202.

In the example of FIG. 1, the DKC_A 100A and the DKC_B 100B have the same configuration. Accordingly, the configuration of the DKC_A 100A is described hereinafter. The DKC_A 100A includes channel adapters (CHAs) 101A and 101B for connecting to the host computer 18 and the other storage subsystem and a disk adapter (DKA) 104 for connecting to the DKU_A 200A.

The DKC_A 100A further includes a cache package (CPK) 102 including a cache memory, microprocessor packages (MPPKs) 103A and 103B including microprocessors for performing internal processing, and an internal network 105 for connecting them. The packages and the adapters are each composed of, for example, a board and circuit components mounted thereon.

In the example of FIG. 1, the DKC_A 100A includes a plurality of CKAs, CHA_A 101A and CHA_B 101B, and a plurality of MPPKs, MPPK_A 103A and MPPK_B 103B. The number of components in the DKC_A 100A depends on the design. For example, the DKC_A 100A can have a plurality of CPKs and DKAs or may have only one CHA.

In the example of FIG. 1, the CHA_A 101A and CHA_B 101B have the same configuration. In this example, the CHA_A 101A is connected to the host computer 18 via a path and the CHA_B 101B is connected to the storage subsystem 10B via a path.

The CHA_A 101A includes a port 111, which is an interface for connecting to the host computer 18, a router 115, which is a transfer circuit to transfer data, and a memory 114 on a board. The router 115 includes a global router (GR) 112 and a local router (LR) 113.

The GR 112 and the LR 113 may be different logical circuits; alternatively, a processor in the router 115 performs the functions of the GR 112 and the LR 113. The GR 112 mainly manages frame transfers between the storage subsystems. The LR 113 manages frame transfers within the DKC_A 100A. A frame is a data unit including a command or a data unit including a command and user data for the command. The details of the processing will be described later.

The CHA_A 101A can include a plurality of ports 111; each port can connect to the host computer. The port 111 converts a protocol used in communication between the host computer 18 and the storage subsystem 10A, such as Fibre Channel over Ethernet (FCoE), into another protocol used in the internal network 105, such as PCI-Express.

The DKA 104 includes a memory 141, an LR 142 to transfer data in the DKC_A 100A, and a port 143 to connect to the DKU_A 200A on a board. The DKA 104 can include a plurality of ports. The port 143 converts a protocol used in communication with the DKU_A 200A, such as FC, into the protocol used in the internal network 105.

The CPK 102 includes a cache memory 121 for temporarily holding user data read or written by the host computer 18 and a memory 122 for holding control information on a board. The memory 122 holds control information to be referred to or updated by the CHA_A 101A, CHA_B 101B, MPPK_A 103A, MPPK_B 103B, and others.

For example, the MPPK_A 103A and MPPK_B 103B are assigned different volumes and handle commands to their respective assigned volumes. In the example of FIG. 1, the MPPK_A 103A and the MPPK_B 103B have the same configuration.

The MPPK_A 103A includes one or more microprocessors (MPs) 132 and a memory 131. In this example, a plurality of microprocessors 132 are included. The number of microprocessors 132 may be one. The plurality of microprocessors 132 may be regarded as one processor. The memory 131 stores programs executed by the microprocessors 132 on the same board and control information to be used by the microprocessors 132.

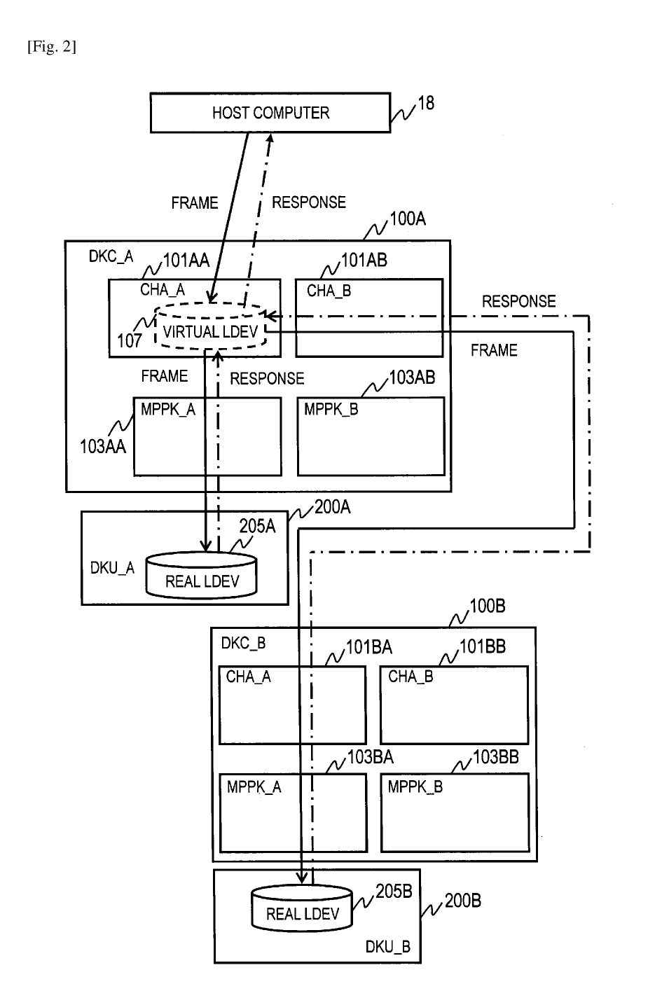

Next, with reference to FIG. 2, an overview of the operation of the storage system in this embodiment will be described. For explanation, some of the elements are denoted by reference signs different from those in FIG. 1. The storage system has a clustered configuration; the storage subsystem 10A is an active subsystem and the storage subsystem 10B is a standby subsystem. When some failure occurs in the storage subsystem 10A, the host computer 18 switches the access target for a volume from the storage subsystem 10A to the storage subsystem 10B.

In the storage subsystems 10A and 10B, the same virtual logical device (LDEV) 107 is defined. In the storage subsystem 10A, a real LDEV 205A is associated with the virtual LDEV 107. In the storage subsystem 10B, a real LDEV 205B is associated with the virtual LDEV 107.

An LDEV is a volume for storing data and is associated with physical storage areas of storage drives. To maintain the service continuity after a failure occurs in the storage subsystem 10A, the identity of data is maintained between the real LDEVs 205A and 205B.

The host computer 18 transmits a write command and write data to the storage subsystem 10A. In the following description, a read command, a write command, or a data unit including a write command and write data is called a frame. In frame transfers in the following description, necessary data in each frame is converted; but the explanation thereof is omitted in this description.

The CHA_A 101AA in the storage subsystem 10A transfers a received frame (including a write command) to the MPPK_A 103AA for the virtual volume 107 (real LDEV 205A) in the DKC_A 100A. The MPPK_A 103AA (the MPs 132 thereof) handles the frame and returns a notice of completion (response) to the CHA_A 101AA.

The CHA_A 101AA in the storage subsystem 10A further transfers the frame (the write command and the write data) to the storage subsystem 10B via the CHA_B 101AB in the storage subsystem 10A.

The CHA_A 101BA in the storage subsystem 10B transfers the frame (including the write command) to the MPPK_A 103BA for the virtual volume 107 (real LDEV 205B) in the DKC_B 100B. The MPPK_A 103BA handles the frame and returns a notice of completion (response) to the CHA_A 101BA in the DKC_B 100B.

The CHA_A 101BA in the storage subsystem 10B transfers the received notice of completion to the storage subsystem 10A. The CHA_B 101AB in the storage subsystem 10A transfers the received notice of completion to the CHA_A 101AA in the DKC_A 100A.

When the CHA_A 101AA in the storage subsystem 10A receives the notices of completion from both of the MPPK_A 103AA in the DKC_A 100A and the MPPK_A 103BA in the other storage subsystem 10B (all the MPPKs), it transmits a notice of completion for the received frame to the host computer 18.

The notice of completion transmitted to the host computer 18 after receipt of the notices of completion from all of the MPPKs assures exact data identity between the real LDEVs 205A and 205B. Depending on the design, receipt of only the notice of completion from the MPPK in the storage subsystem 10A which received a write command from the host computer 18 can be the condition for the response to the host computer 18.

As described above, frame transfer from the storage subsystem 10A to the storage subsystem 10B is performed by the CHAs not via any MPPK (MP) in the storage subsystem 10A. This configuration achieves low overhead caused by transferring a frame and a response and low concentration of load to the MPPKs.

The overview of write command processing has been explained with reference to FIG. 2. In the case where a read command is received, the DKC_A 100A transmits read data held in the cache data or the DKU_A 200A in the local storage subsystem 10A to the host computer 18 as a response without transferring the frame to the storage subsystem 10B.

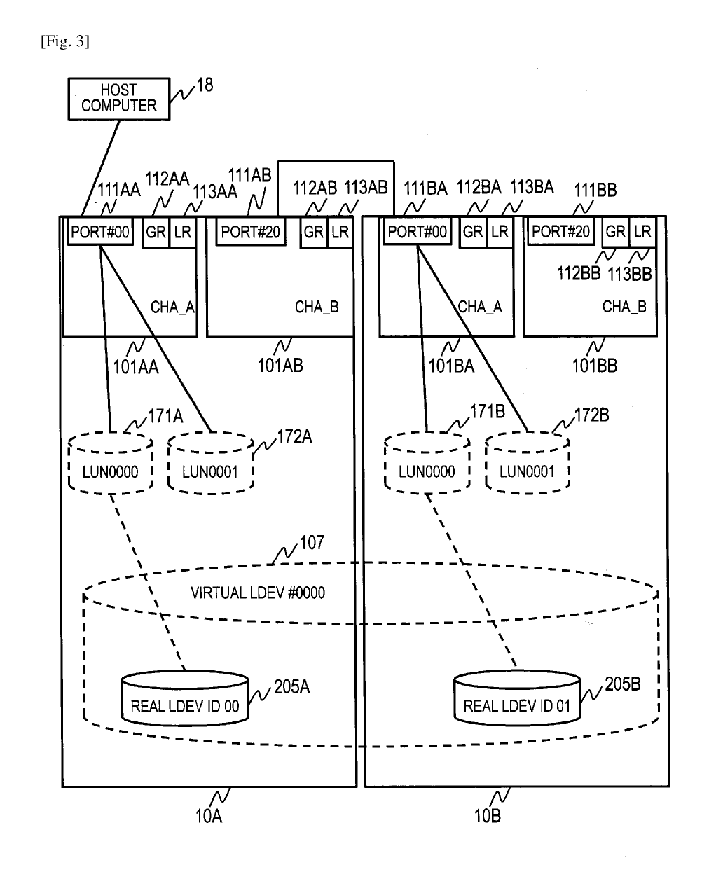

Hereinafter, the storage system in this embodiment will be described with reference to a more specific example. FIG. 3 illustrates an exemplary volume configuration in the storage system in this embodiment. For clearer explanation, reference signs different from those in the foregoing drawings are assigned to some elements in FIG. 3.

In FIG. 3, the CHA_A 101AA in the storage subsystem 10A includes a port 111AA, a GR 112AA, and an LR 113AA. The port number of the port 111AA is 00. For example, port numbers are unique to a storage subsystem. The CHA_B 101AB includes a port 111AB, a GR 112AB, and an LR 113AB. The port number of the port 111AB is 20.

The CHA_A 101BA in the storage subsystem 10B includes a port 111BA, a GR 112BA, and an LR 113BA. The port number of the port 111BA is 00. The CHA_B 101BB includes a port 111BB, a GR 112BB, and an LR 113BB. The port number of the port 111BB is 20. A path for data transfer is provided between the port 111AB in the storage subsystem 10A and the port 111BA in the storage subsystem 10B.

In the storage subsystem 10A, two logical units (LUs) 171A and 172A are defined (configured) under the port 111AA. LUs are volumes accessed by the host computer 18. The LU numbers (LUNs) of the LUs 171A and 172A are 0000 and 0001, respectively.

The host computer 18 designates a port number and an LUN to access an LU. In the storage subsystem 10A, the LU 171A is associated with the real LDEV 205A. The real LDEV ID of the real LDEV 205A is 00. Real LDEV IDs are unique to the storage system. Write data designated with an address in the LU 171A is stored in the storage area at the corresponding address in the real LDEV 205A.

In the storage subsystem 10B, two LUs 171B and 172B are defined (configured) under the port 111BA. The LUNs of the LUs 171B and 172B are 0000 and 0001, respectively. The LU 171B is associated with the real LDEV 205B in the storage subsystem 10B. The real LDEV ID of the real LDEV 205B is 01.

In the storage subsystems 10A and 10B, a virtual LDEV 107 is defined (configured). The virtual LDEV number (virtual LDEV#) of the virtual LDEV 107 is 0000. Virtual LDEV numbers are unique to the storage system.

The real LDEVs 205A and 205B are associated with the virtual LDEV 107 and the real LDEVs 205A and 205B are associated with each other via the virtual LDEV 107. The LUs 171A and 171B are also associated with the virtual LDEV 107. In this example, a virtual LDEV is defined in the storage system; however, virtual LDEVs do not need to be defined in order to associate LUs with LDEVs.

The real LDEVs 205A and 205B constitute a copy pair, in which data identity is maintained. Write data written to the real LDEV 205A is transferred to the storage subsystem 10B and written to the real LDEV 205B. The real LDEV 205A is referred to as a primary real LDEV or a local real LDEV and the real LDEV 205B is referred to as a secondary real LDEV or a remote real LDEV.

The host computer 18 accesses the LU 171A in the storage subsystem 10A via the port 111AA therein. The write data is stored in the real LDEV 205A. The write data is also stored in the remote real LDEV 205B via the port 111AB in the storage subsystem 10A and the port 111BA in the storage subsystem 10B.

When a failure occurs in the storage subsystem 10A, the path management program in the host computer 18 switches the access path to be used from the access path to the storage subsystem 10A to the access path to the storage subsystem 10B. In the example of FIG. 3, the switched access path connects to the port 111BA in the storage subsystem 10B. The host computer 18 accesses the LU 171B at the port 111BA to access the real LDEV 205B.

The remote real LDEV 205B is also associated with an LU at a port different from the port 111BA and the host computer 18 may access the real LDEV 205B via the different port and the LU.

Hereinafter, processing in the storage system having the volume configuration shown in FIG. 3 will be described. FIG. 4 illustrates transfers of frames and responses to the frames (notices of completion) in the computer system. In FIG. 4, the frames are frames for a write command and a frame includes a write command, write data (user data), and identifiers required to transfer the frame. Some of the frames do not need to include write data. With reference to FIG. 4 and other drawings, data transfers to store user data in the real LDEVs 205A and 205B and processing in each element in the data transfers will be described.

In FIG. 4, the host computer 18 first transmits a frame 401 to the storage subsystem 10A. The frame 401 includes a write command and write data and designates the port 111AA and the LUN 0000 in the storage subsystem 10A. The GR 112AA in the CHA_A 101AA at the port 111AA receives the frame 401 via the port 111AA.

The GR 112AA converts a part of the data in the received frame 401 to generate a frame 402 and transfers it to the LU 113AA in the storage subsystem 10A. Furthermore, the GR 112AA converts a part of the data in the received frame 401 to generate a frame 403 and transfers it to the other storage subsystem 10B (the GR therein). The frame 403 is transferred to the storage subsystem 10B via or not via another CHA.

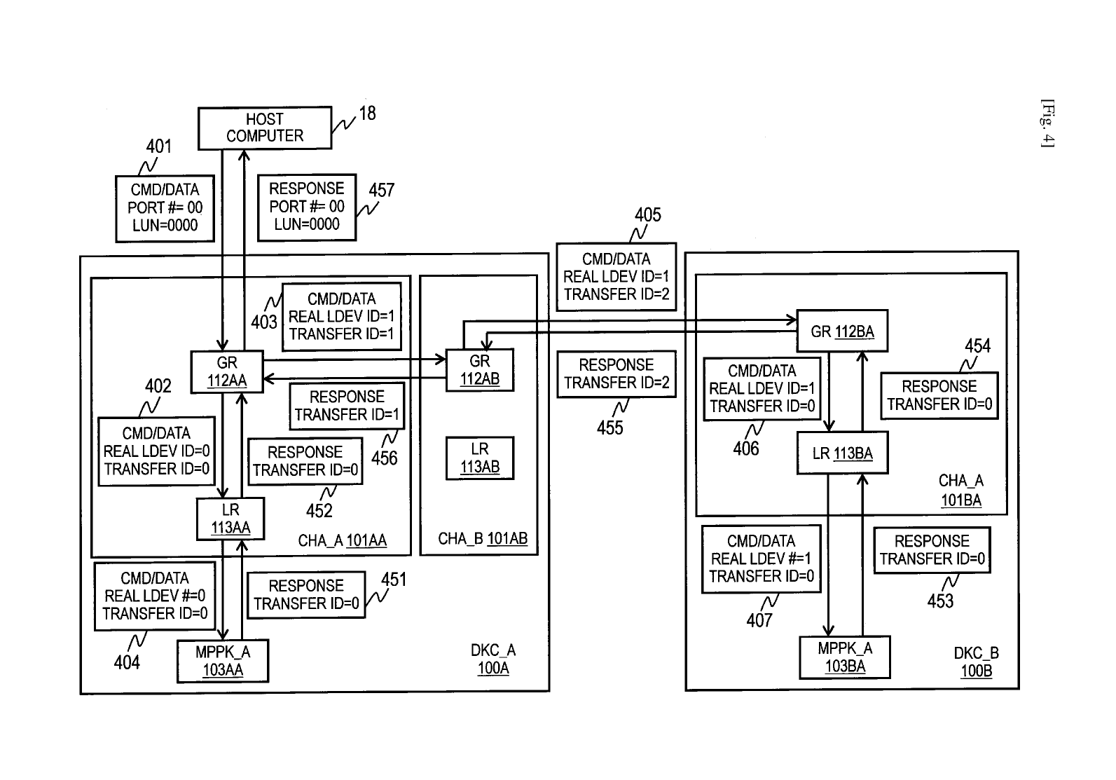

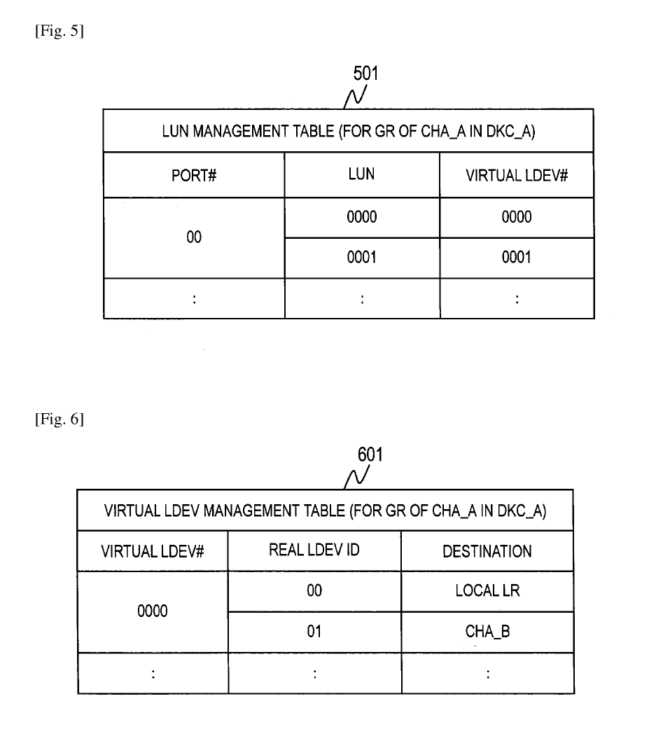

FIGS. 5 and 6 illustrates exemplary tables referred to by the GR 112AA in order to process the frame 401 received from the host computer 18. In the example of FIG. 4, the tables are referred to in order to generate the frames 402 and 403 (to determine the destinations thereof). FIG. 5 illustrates an exemplary LUN management table 501 and FIG. 6 illustrates an exemplary virtual LDEV management table 601.

The LUN management table 501 shown in FIG. 5 is a table for managing LUs defined under the ports of the CHA_A 101AA and has columns of port numbers (port #), LUNs, virtual LDEV numbers (virtual LDEV #). Each entry associates an LU identified by a port number and an LUN with a virtual LDEV identified by a virtual LDEV number. In this example, the entries held in the table are all the LUs defined under the port of the CHA_A 101AA.

LUNs are unique values to each port and virtual LDEV numbers are unique values to the storage subsystems 10A and 10B (the storage system and the computer system). In the LUN management table 501, the port number column stores port numbers of the ports owned by the CHA_101AA.

The virtual LDEV management table 601 shown in FIG. 6 has columns of virtual LDEV numbers (virtual LDEV #), real LDEV IDs, and destinations and associates each virtual LDEV identified by a virtual LDEV number with a destination of a frame (a write command and write data) from the host computer 18 to the virtual LDEV. In the virtual LDEV management table 601, the virtual LDEV number column stores values of all the virtual LDEV numbers held in the LUN management table 501.

The LUN management table 501 and the virtual LDEV management table 601 are held in, for example, the control information memory 122 in the CPK 102. The MPs 132 create and update the LUN management table 501 and the virtual LDEV management table 601.

In this embodiment, tables (information) may be held in any memory if the memory can be accessed by the device which uses (updates or refers to) the table. It is sufficient if the information contained in each table include information required for the device that uses the table.

The GR 112AA refers to the frame 401 received from the host computer 18 to acquire the port number of the port 111AA that received the frame and the LUN to be accessed. The GR 112AA acquires the virtual LDEV number associated with the acquired port number and the LUN from the LUN management table 501. In this example, the virtual LDEV number 0000 is acquired.

The GR 112AA further refers to the virtual LDEV management table 601 to identify the real LDEV ID and the destination of the frame associated with the acquired virtual LDEV number. In this example, the real LDEV IDs associated with the virtual LDEV number 0000 are 00 and 01 and the destinations are the local LR and the CHA_B. The local LR means the LR in the same CHA (the same router 115) which includes the GR referring to the virtual LDEV management table 601. The CHA_B means the CHA_B in the same DKC.

The GR 112AA adds a real LDEV ID=00 (the real LDEV ID=0 in FIG. 4) and a transfer frame ID=0000 (the transfer ID=0 in FIG. 4) to the frame 401 to generate a frame 402. The transfer frame ID (inclusive of the other transfer frame IDs explained later) is a unique value to each CHA. The GR 112AA transmits the frame 402 to the LR 113AA in the local router 115.

The GR 112AA adds a real LDEV ID=01 (the real LDEV ID=1 in FIG. 4) and a transfer frame ID=0001 (the transfer ID=1 in FIG. 4) to the frame 401 to generate a frame 403. The GR 112AA may delete the LUN in the frame 401. The GR 112AA transmits the frame 403 to the CHA_B 101AB in the local DKC.

This embodiment uses transfer frame IDs to manage transfer frames. Specifically, each GR manages transfer frame IDs assigned to the received frames and transfer frame IDs assigned to the frames the GR transfers (transmits) to properly manage the frames transferred in the storage system and the receipts of the responses thereto.

A GR uses a transfer frame management table for frame management. The transfer frame management table includes a received frame management table to manage received frames and a transmitted frame management table to manage transmitted (transferred) frames. The GR updates and refers to these tables, which are held in, for example, the control information memory 122 in the local DKC or the memory 114 in the local CHA.

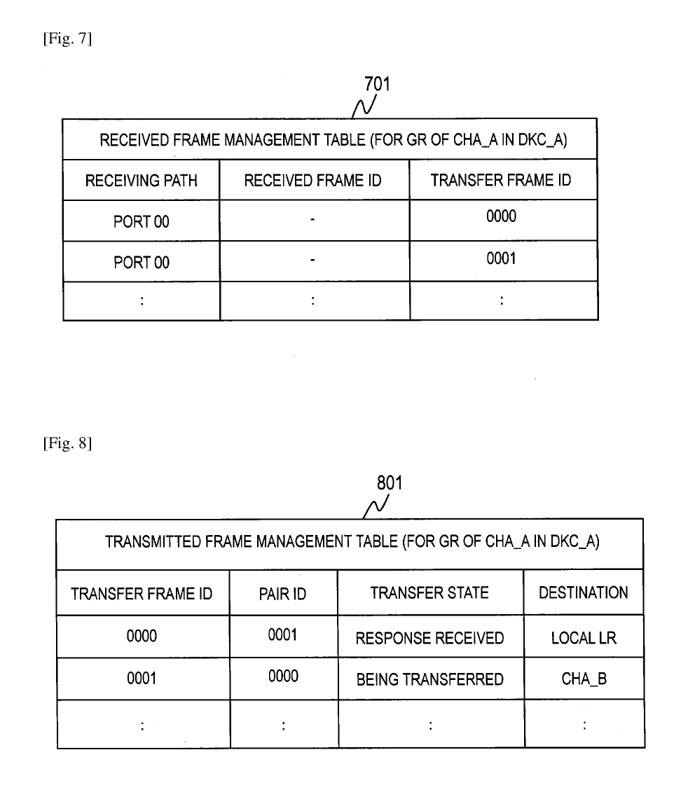

FIG. 7 illustrates an exemplary received frame management table 701 to be used by the GR 112AA in the CHA_A 101AA in the DKC_A 100A and FIG. 8 illustrates an exemplary transmitted frame management table 801 to be used by the GR 112AA. Upon receipt of a frame, the GR 112AA adds an entry to each of the received frame management table 701 and the transmitted frame management table 801; upon receipt of a notice of completion, it updates the relevant entry in the transmitted frame management table 801.

The received frame management table 701 has columns of receiving paths, received frame IDs, and transfer frame IDs and associates their values with one another. The receiving path indicates the sender of the received frame. The received frame ID indicates the transfer frame ID assigned to the received frame. The transfer frame ID indicates the transfer frame ID assigned to the transmitted frame.

In FIG. 7, the entry at the top represents the information on the frame 402 in FIG. 4 and the next entry represents the information on the frame 403. In this example, the GR 112AA receives the frame 401 at the port 111AA having the port number=00 and assigns a transfer frame ID=0000 to the frame 402. The GR 112AA further assigns the transfer frame ID=0001 to the frame 403. Since the frame 401 does not have a transfer frame ID, there are no received frame IDs for these entries (as denoted by hyphens in FIG. 7).

As shown in FIG. 8, the transmitted frame management table 801 has columns of transfer frame IDs, pair IDs, transfer states, and destinations and associates their values with one another. The transfer frame ID indicates the transfer frame ID assigned to the transmitted frame and the pair ID indicates the transfer frame ID assigned to the other frame in the frame pair generated from the same frame. The transfer state indicates the state of the transmitted frame. The destination indicates the transfer destination (transmission destination) of the transmitted frame and is acquired from the virtual LDEV management table 601.

The pair ID (transfer frame ID) enables proper management of frames concerning the same write command and responses thereto. In particular, the pair ID helps assurance of completion of processing of the same write command in the two storage systems 10A and 10B and conservation of the volume data identity between the storage systems 10A and 10B, as will be described later.

In FIG. 8, the entry at the top represents the information on the frame 402 in FIG. 4 and the next entry represents the information on the frame 403. The frames 402 and 403 are a frame pair generated from the same received frame 401 and include the same write command and write data. The transfer frame ID of the frame 403, which is the partner of the frame 402, is 0001 and the transfer frame ID of the frame 402, which is the partner of the frame 403, is 0000.

the transfer state column, “RESPONSE RECEIVED” means that a response to the transferred frame has been received. “BEING TRANSFERRED” means that a response to the transferred frame is being waited after the transmission of the frame. The values in the destination column are the same as the values in the virtual LDEV management table 601.

In FIG. 4, the LR 113AA in the CHA_A 101AA receives the frame 402 and transmits a frame 404 to the MPPK_A 103AA. The LR 113AA converts the value of the real LDEV ID in the frame 402 into the corresponding real LDEV number. This conversion can be omitted.

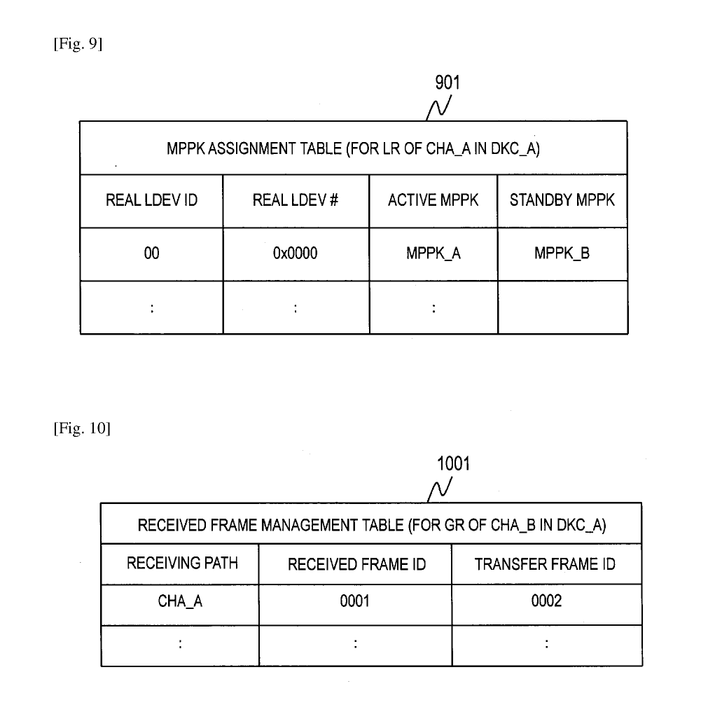

The LR 113AA refers to the MPPK assignment table 901 shown in FIG. 9 to identify the destination MPPK of the frame 404 and the corresponding real LDEV number, from the value of the real LDEV ID assigned to the frame 402.

FIG. 9 illustrates an exemplary MPPK assignment table 901 to be used by the LR 113AA. The MPPK assignment table 901 is held in, for example, the memory 114 in the CHA_A 101AA or the control information memory 122 in the DKC_A 100A. For example, the GR 112AA, LR 113AA, or one of the MPs 132 in the DKC_A 100A updates the MPPK assignment table 901.

The MPPK assignment table 901 has columns of real LDEV IDs, real LDEV numbers (real LDEV #), active MPPKs, and standby MPPKs and associates their values with one another. The real LDEV numbers are the numbers unique to the DKC. The active MPPK indicates the MPPK which is active to process commands to the real LDEV. The standby MPPK indicates the MPPK which is to process commands to the real LDEV when some failure occurs in the active MPPK.

The frame 402 includes a real LDEV ID of 00. The LR 113AA refers to the MPPK assignment table 901 to identify the active MPPK to process commands to the real LDEV of the real LDEV ID=00 as the MPPK_A 103AA. The LR 113AA transmits the frame 404 to the MPPK_A 103AA. The frame 404 indicates the real LDEV number=0x0000 (0 in FIG. 4) and the transfer frame ID=0000 (0 in FIG. 4).

The LR 113AA stores the write data in the cache memory 121. The frame 404 includes or does not include the write data. The MPPK_A 103AA processes the write command included in the transferred frame 404 and transmits a response 451 including the notice of completion for the processing to the LR 113AA, which is the sender of the frame 404. To the notice of completion in the response 451, the same transfer frame ID as the frame 404 is assigned and the value thereof is 0000 in this example.

The MPPK_A 103AA transfers the write data to the DKU_A 200A using the DKA 104 in order to store the write data to the real LDEV 205A at the address designated by the write command. The write data in the frame 404 or the write data in the cache memory 121 are transferred to the DKA 104. The MPPK_A 103AA returns a response 451 before or after it transfers the write data to the DKU_A 200A.

Upon receipt of the response 451, the LR 113AA transmits a response 452 including a notice of completion of processing the write command by the MPPK_A 103AA and a transfer frame ID=0000 to the GR 112AA like the response 451. Upon receipt of the response 452, the GR 112AA updates the transmitted frame management table 801 by changing the transfer state of the relevant entry (the entry of the transfer frame ID=0000) from “BEING TRANSFERRED” to “RESPONSE RECEIVED”.

With reference to the transmitted frame management table 801, the GR 112AA determines whether the entry includes a value of the pair ID. In this example, the entry having the transmitted frame ID=0000 includes a value of the pair ID (0001). The GR 112AA refers to the entry having the pair ID (the entry for the pair partner) and acquires the value in the cell of the transfer state in the partner entry. If the value is “BEING TRANSFERRED”, the GR 112AA waits for a response for the partner entry.

If the value is “RESPONSE RECEIVED”, the GR 112AA transmits a response 457 to the host computer 18. The response 457 is a notice of completion for the write command from the host computer 18. Through this operation, the identity of the storage data between the two storage subsystems 10A and 10B is assured with more certainty. At this stage in this example, it is assumed that the value is “BEING TRANSFERRED”.

In FIG. 4, the CHA_B 101AB in the DKC_A 100A receives a frame 403 from the CHA_A 101AA. The CHA_B 101AB is a CHA to transfer frames to the other storage subsystem 10B.

The GR 112AB in the CHA_B 101AB receives the frame 403 and transmits a frame 405 converted from the frame 403 to the other storage subsystem 10B. The write command and the write data are transferred to the storage subsystem 10B by the frame 405, which indicates a real LDEV ID=01 and a transfer frame ID=0002.

The GR 112AB determines the destination of the frame with reference to a not-shown virtual LDEV management table. The table configuration of the virtual LDEV management table may be the same as the virtual LDEV management table shown in FIG. 6. The virtual LDEV management table referred to by the GR 112AB indicates that write commands and the write data for the frames including a real LDEV ID=01 are to be transferred to the DKC_B 100B.

Like the GR 112AA, the GR 112AB manages frames using a transfer frame management table. FIGS. 10 and 11 illustrate an exemplary received frame management table 1001 and an exemplary transmitted frame management table 1101, respectively, to be used by the GR 112AB. These tables are stored in, for example, the memory 114 in the CHA_B 101AB or the control information memory 112 in the DKC_A 100A.

Upon receipt of a frame, the GR 112AB adds an entry to each of the received frame management table 1001 and the transmitted frame management table 1101; upon receipt of a response to the frame, it updates a relevant entry in the transmitted frame management table 1101.

The received frame management table 1001 and the transmitted frame management table 1101 have the same table configurations as the received frame management table 701 and the transmitted frame management table 801. In FIG. 10, the entry at the top of the received frame management table 1001 represents the information on the frame 403 (and the frame 405). The cell of the receiving path indicates the CHA_A 101AA of the sender of the frame; the cell of the received frame ID indicates the value of the transfer frame ID of the frame 403; and the cell of the transfer frame ID indicates the value of the transfer frame ID of the frame 405.

In FIG. 11, the entry at the top of the transmitted frame management table 1101 represents the information on the frame 405. The frame 405 does not form a pair. The destination of the frame 405 is the DKC_B 100B in the other storage subsystem 10B. The GR 112AB transmits the frame 405 to the port 111BA in the DKC_B 100B via the port 111AB shown in FIG. 3.

For example, the virtual LDEV management table referred to by the GR 112AB indicates the DKC_B 100B and the port number of the destination in the cell of the destination in the entry of the real LDEV ID 01; the GR 112AB transmits the frame 405, designating the destination port. The port 111AB and the port 111BA may be directly connected with a line.

In the storage subsystem 10B, the GR 112BA in the CHA_A 101BA receives the frame 405 via the port 111BA. The GR 112BA determines the destination of the write command and the write data included in the frame 405 with reference to management tables.

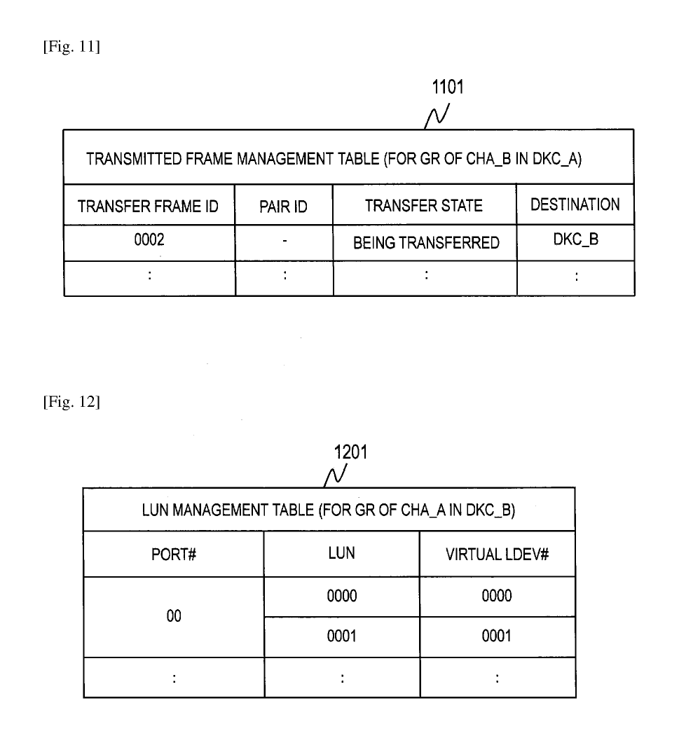

FIGS. 12 and 13 illustrate an exemplary LUN management table 1201 and an exemplary virtual LDEV management table 1301, respectively, referred to by the GR 112BA in the CHA_A 101BA. These tables have the same configurations as the LUN management table 501 and the virtual LDEV management table 601 referred to by the GR 112AA in the storage subsystem 10A.

These tables 1201 and 1301 are held in, for example, the memory 114 in the CHA_A 101BA or the control information memory 112 in the DKC_B 100B and are updated by one of the MPs 132 in the DKC_B 100B.

The LUN management table 1201 includes information on all the LUs defined under the CHA_A 101BA and the virtual LDEV management table 1301 includes information on all the virtual LDEVs held in the LUN management table 1201.

The frame 405 includes a value of a real LDEV ID. Accordingly, the GR 112BA can acquire information on the destination from the virtual LDEV management table 1301 without referring to the LUN management table 1201.

In another example, the frame 405 does not need to include the real LDEV ID if it includes an LUN. For example, the write command in the frame 405 includes an LUN and the LUN management table 1201 manages LUNs. Then, the GR 112BA can determine the destination with reference to the LUN management table 1201 and the virtual LDEV management table 1301. The frame 405 may include a virtual LDEV number instead of a real LDEV ID.

In this example, the virtual LDEV management table 1301 indicates that the write command having the real LDEV ID=01 and the write data is to be transferred to the local LR, or the LR 113BA in the CHA_A 101BA. As shown in FIG. 4, the GR 112BA transmits the frame 406 to the LR 113BA. The frame 406 includes a write command and write data and indicates the real LDEV ID=01 and the transfer frame ID=0000.

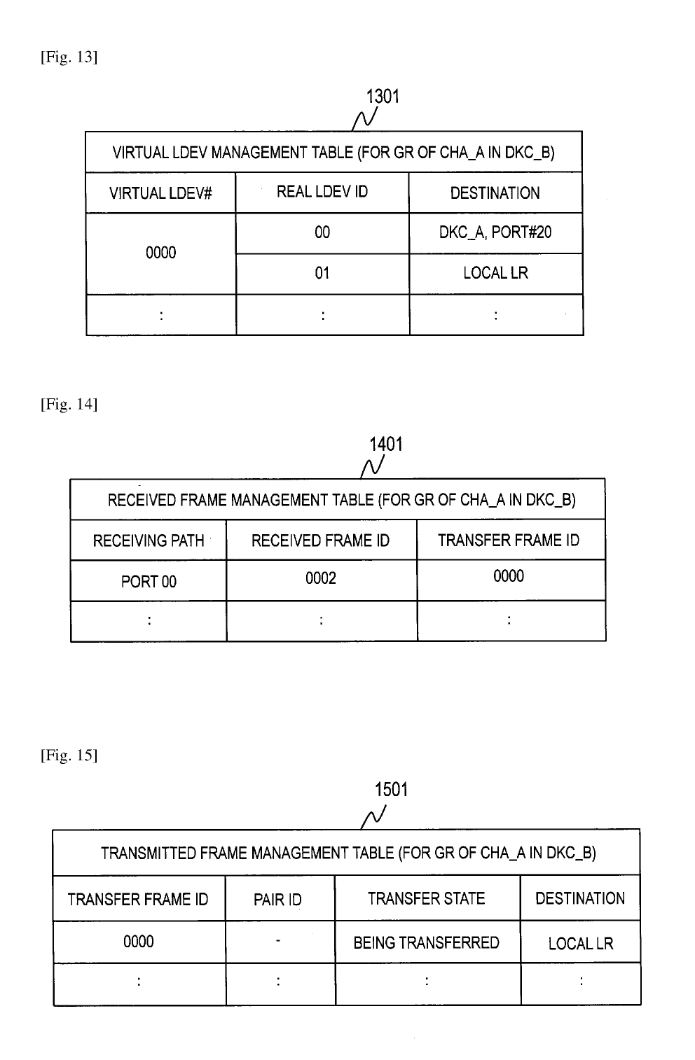

Like the GRs in the storage subsystem 10A, the GR 112BA manages frames using a transferred frame management table. FIGS. 14 and 15 illustrate an exemplary received frame management table 1401 and an exemplary transmitted frame management table 1501, respectively, to be used by the GR 112BA. These tables are stored in, for example, the memory 114 in the CHA_A 101BA or the control information memory 112 in the DKC_B 100A.

Upon receipt of a frame, the GR 112BA adds an entry to each of the received frame management table 1401 and the transmitted frame management table 1501; upon receipt of a response to the frame, it updates a relevant entry in the transmitted frame management table 1501.

The received frame management table 1401 and the transmitted frame management table 1501 have the same table configurations as the received frame management table 701 and the transmitted frame management table 801, respectively. In FIG. 14, the entry at the top of the received frame management table 1401 represents the information on the frame 405 (and the frame 406).

The cell of the receiving path indicates the port 111BA (port number 00) of the device which received the frame 405 (the frame sender); the cell of the received frame ID indicates the value of the transfer frame ID of the frame 405; and the cell of the transfer frame ID indicates the value of the transfer frame ID of the frame 406. In this example, the GR 112BA assigns the frame 406 a transfer frame ID different from that of the frame 405.

In FIG. 15, the entry at the top of the transmitted frame management table 1501 represents the information on the frame 406. The frame 406 does not form a pair. The destination of the frame 406 is the LR 113BA in the local router. In the example of FIG. 15, the GR 112BA has not received a response and the cell of the transfer state indicates “BEING TRANSFERRED”.

In FIG. 4, the LR 113BA receives the frame 406 and transmits the frame 407 to the MPPK_A 103BA. The LR 113BA refers to the MPPK assignment table 1601 shown in FIG. 16 for the real LDEV ID included in the frame 406 to identify the destination MPPK of the frame.

FIG. 16 illustrates an exemplary MPPK assignment table 1601 to be used by the LR 113BA. The MPPK assignment table 1601 is stored in, for example, the memory 114 in the CHA_A 101BA or the control information memory 122 in the DKC_B 100B. For example, one of the MPs 132 in the DKC_B 100B, the GR 112BA, or the LR 113BA updates the MPPK assignment table 1601.

The MPPK assignment table 1601 has the same table configuration as the MPPK assignment table 901. The frame 406 includes a real LDEV ID of 01. The LR 113BA refers to the MPPK assignment table 1601 to identify the active MPPK to process the write command for the real LDEV having the real LDEV ID=01 as the MPPK_A 103BA.

The LR 113BA transmits a frame 407 to the MPPK_A 103BA. The frame 407 indicates the real LDEV number=0x0001 (in FIG. 4, the real LDEV #=1) and the transfer frame ID=0000 (in FIG. 4, transfer ID=0). The method of identifying the real LDEV number is the same as that in the DKC_A 100A.

The LR 113BA stores the write data in the cache memory 121. The frame 407 includes or does not include the write data. The MPPK_A 103BA processes the write command included in the transferred frame 407 and transmits a response 453 including a notice of completion for the processing to the LR 113BA of the sender of the frame 407. The notice of completion in the response 453 is assigned the same transfer frame ID as the frame 407 and the value is 0000 in this example.

The MPPK_A 103BA transfers the write data to the DKU_B 200B using the DKA 104 to store the write data at the address in the real LDEV 205B designated by the write command. The write data in the frame 407 or the write data in the cache memory 121 is transferred to the DKA 104. The MPPK_A 103BA returns the response 453 before or after it transfers the write data to the DKU_B 200B.

The LR 113BA transmits a response 454 to the frame 406 to the GR 112BA. In FIG. 4, the LR 113BA transmits the response 454 which includes a notice of completion for the write command and indicates the transfer frame ID=0000 like the response 453, to the GR 112BA.

Upon receipt of the response 454, the GR 112BA identifies the value of the transfer frame ID included therein and updates the transfer state in the entry (the entry having the transfer frame ID=0000) in the transmitted frame management table 1501 (FIG. 15), from “BEING TRANSFERRED” into “RESPONSE RECEIVED”. The GR 112BA further determines whether the entry includes a value of the pair ID. In this example, the entry having the transfer frame ID=0000 does not include a pair ID.

Upon receipt of the response 454, the GR 112BA transmits a response 455 to the frame 405 to the storage subsystem 10A. Specifically, the GR 112BA refers to the received frame management table 1401 (FIG. 14) and acquires information on the received frame ID (in this example, 0002) for the transfer frame ID=0000 and the receiving path. The GR 112BA generates the response 455 including the acquired received frame ID as a transferred frame ID.

The GR 112BA transmits the response 455 including a notice of completion to the port 111AB (port number 20) of the receiving path indicated by the received frame management table 1401. The GR 112BA may have information indicating the destination of the response 455 is the port 111AB (port number 20) in the storage subsystem 10A and instructs the port 111BA of it; alternatively, the port 111BA may have information for associating a transfer frame ID with a destination port and transfer the response 455 with reference to the information.

After transmitting the response 455 indicating the same transfer frame ID=0002 as the frame 405 to the sender port 111AB (port number 20) of the frame 405 via the port 111BA, the GR 112BA deletes the relevant entries in the received frame management table 1401 and the transmitted frame management table 1501.

The CHA_B 101AB in the storage subsystem 10A receives the response 455. Upon receipt of the response 455, the GR 112AB in the CHA_B 101AB generates a response 456 and transmits it to the CHA_A 101AA. The response 456 includes a transfer frame ID=0001.

Specifically, upon receipt of the response 455, the GR 112AB identifies the value of the transfer frame ID (0002) included therein and updates the transfer state of the relevant entry (the entry having the transfer frame ID=0002) in the transmitted frame management table 1101 (FIG. 11) from “BEING TRANSFERRED” into “RESPONSE RECEIVED”. The GR 112AB further determines whether the entry includes a value of a pair ID. In this example, the entry having the transfer frame ID=0002 does not include a pair ID.

After receipt of the response 455, the GR 112AB transmits a response to the frame 403 to the CHA_A 101AA. Specifically, the GR 112AB refers to the received frame management table 1001 (FIG. 10) and acquires information on the received frame ID (in this example, 0001) and the receiving path for the transfer frame ID=0002.

The GR 112AB generates a response 456 including the acquired received frame ID as a transfer frame ID and transmits the generated response 456 to the CHA_A 101AA indicated by the received frame management table 1001 as the receiving path. After transmitting the response 456, the GR 112AB deletes the relevant entries in the received frame management table 1001 and the transmitted frame management table 1101.

The GR 112AA in the CHA_A 101AA receives the response 456, identifies the value of the transfer frame ID (0001) included in the response, and updates the transfer state of the relevant entry (the entry having the transmitted frame ID=0001) in the transmitted frame management table 801 (FIG. 8) from “BEING TRANSFERRED” into “RESPONSE RECEIVED”.

The GR 112AA further determines whether the entry includes a value of a pair ID. In this example, the entry having the transfer frame ID=0001 includes a pair ID=0000. The GR 112AA refers to the transmitted frame management table 801 for the entry including the identified pair ID as a transfer frame ID to find the transfer state. In this example, the value of the transfer state cell of the entry having the transfer frame ID=0000 is “RESPONSE RECEIVED”.

In response to the write command in a frame pair of two transferred frames (frames having the transfer frame IDs=0001 and 0002), notices of completion have been received from both of the MPPKs in the storage subsystems 10A and 10B; hence, the GR 112AA generates a response 457 including a notice of completion for the frame 401 (write command) received from the host computer 18. The GR 112AA refers to the received frame management table 701 (FIG. 7) and identifies the receiving path for the frames having the transfer frame IDs=0001 and 0002.

The GR 112AA transmits a response 457 to the port 111AA (port number 00) of the receiving path indicated by the received frame management table 701. The GR 112AA may have information indicating the destination of the response 457 is the host computer 18 (a port thereof) and inform the port 111AA of it, or may have information to associate a transfer frame ID with a destination port and transfer the notice of completion 457 with reference to the information.

In the foregoing example described with reference to FIGS. 3 to 16, all the frames and responses (notices of completion) are received normally. Hereinafter, processing in the case of a failure in one of the MPPKs in the same configuration will be described.

In this embodiment, when a failure occurs in an MPPK of the destination of a frame, the LR transmits the frame to the standby MPPK instead of the active MPPK. This operation enables continuous processing of the command in the case of a failure in the MPPK, increasing failure tolerance in the storage subsystem. The MPPKs can be switched in processing both of a write command and a read command.

The GR or LR determines whether a failure occurs in an MPPK of the frame destination in the local storage subsystem. In the example described below, the GR determines whether a failure occurs in the MPPK of the frame destination, and in the case of a failure, it controls the LR to send the frame to the standby MPPK instead of the active MPPK. The standby MPPK is an MPPK different from the active MPPK, and has been assigned to a real LDEV different from the real LDEV the active MPPK has been assigned to or has not been assigned to any real LDEV.

Taking an example of FIG. 4, it is assumed that a failure occurs in the MPPK_A 103AA in the storage subsystem 10A. The failed MPPK_A 103AA cannot normally process the frame 403 so that it cannot transmit the response 451. For example, upon determination that a failure occurs in the MPPK_A 103AA, the GR 112AA makes a change in the MPPK assignment table 901 for the LR 113AA.

As shown in FIG. 9, the MPPK assignment table 901 indicates the active MPPK and the standby MPPK for each real LDEV. As described above, the LR 113AA refers to the MPPK assignment table 901 and transmits a frame to the active MPPK assigned the real LDEV designated by the frame.

When the GR 112AA determines that a failure occurs in the active MPPK_A 103AA in processing a frame having the real LDEV ID=00, it changes the value in the active MPPK cell of the relevant entry in the MPPK assignment table 901 into the value in the standby MPPK cell of the same entry. That is to say, the value in the active MPPK cell is changed from MPPK_A into MPPK_B. After the change of the active MPPK, the LR 113AA transmits frames having the real LDEV ID=00 to the MPPK_B 103AB in processing those frames.

The GR 112AA may instruct the LR 113AA to transmit a frame to the standby MPPK with designation of a real LDEV ID, without changing a value in the MPPK assignment table 901. The instructed LR 113AA selects the MPPK which has the identifier held in the standby MPPK cell of the MPPK assignment table 901 to transmit the frame having the real LDEV ID.

The MPPK assignment table does not need to have a standby MPPK column. The GR 112 can acquire the identifier of the standby MPPK for the real LDEV ID from other available information and change the value in the active MPPK cell with the acquired value in the MPPK assignment table.

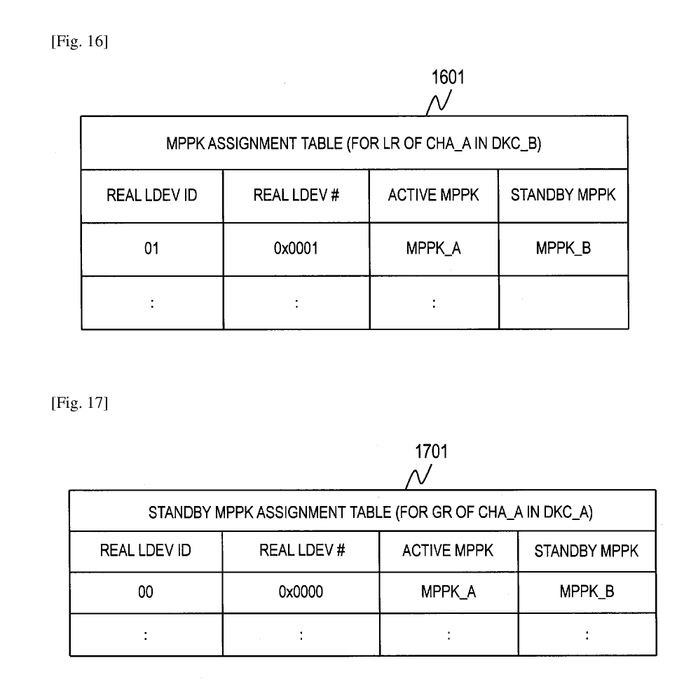

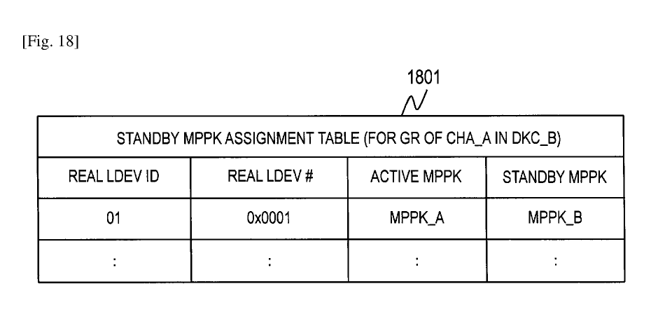

FIG. 17 illustrates an exemplary standby MPPK assignment table 1701 to be used by the GR 112AA in the DKC_A 100A and FIG. 18 illustrates an exemplary standby MPPK assignment table 1801 to be used by the GR 112BA in the DKC_B 100B. The standby MPPK assignment tables 1701 and 1801 have the same configuration including columns of real LDEV IDs, real LDEV numbers (real LDEV #), active MPPKs, and standby MPPKs to associate their values with one another.

For example, when the GR 112AA or the GR 112BA determines that a failure occurs in an MPPK in processing a frame, it refers to the standby MPPK assignment table 1701 or 1801, acquires the identifier of the standby MPPK from the entry having the real LDEV ID in the frame, and changes the value in the active MPPK cell with the acquired value in the entry having the same real LDEV ID in the MPPK assignment table 901 or 1601.

In each of the standby MPPK assignment tables, an active MPPK and a standby MPPK are assigned to each of the real LDEVs which the LR in the same CHA as the GR using the table is assigned to. The active MPPK indicates the MPPK of the destination of write commands for the real LDEV of the entry and the standby MPPK indicates the MPPK that transmits frames in the case of a failure in the active MPPK. The standby MPPK for a real LDEV can be the active MPPK for a different real LDEV.

To determine occurrence of a failure in an active MPPK, some methods can be employed. For example, the GR 112 refers to a failure management table (not shown) to determine the occurrence of a failure in the MPPK. The failure management table indicates an MPPK in the DKC in which a failure occurs and is held in, for example, the control information memory 122 in the CPK 102 in the DKC.

In a DKC, MPPKs send and receive monitoring data between each other to check a failure in the other one. When one of the MPPK detects a failure in another MPPK, the MPPK registers the failed MPPK in the failure management table.

The GR 112 can determine the occurrence of a failure in an MPPK depending on whether a response is received from the MPPK (LR 113). For example, if the LR 113 does not receive a response from an MPPK when a predetermined time has passed since a frame was sent to the MPPK, it notifies the GR 112 of it. When the GR 112 receives the notice, it determines that a failure occurs in the MPPK.

The GR 112 may determine the occurrence of a failure using both of the receipt of the response from the MPPK and the information in the failure management table. For example, if the GR 112 does not receive a response from the MPPK when a predetermined time has passed and the failure management table indicates occurrence of a failure in the MPPK, the GR 112 determines that a failure occurs in the MPPK. For the determination of a failure in an MPPK by the LR 113, these methods can be employed.

Hereinafter, processing by some elements (such as the GR 112 and the LR 113) in the storage system to process a frame received from the host computer 18 will be described with reference to some flowcharts. The following description supports the example which has been described with reference to FIGS. 3 to 17 and also is applicable to other system configuration or other frame.

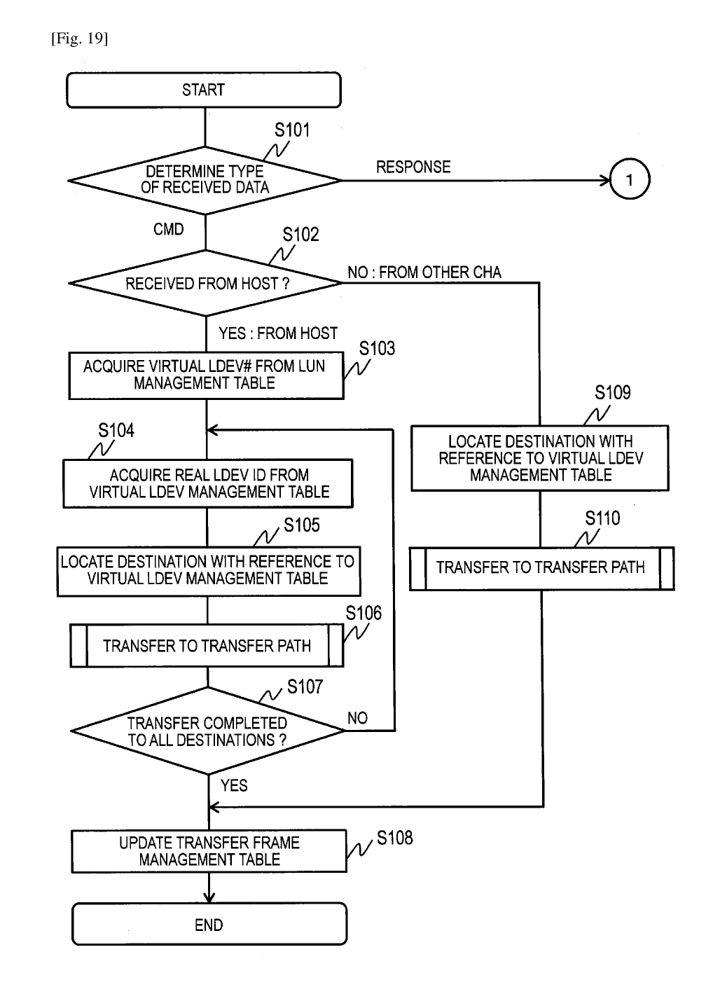

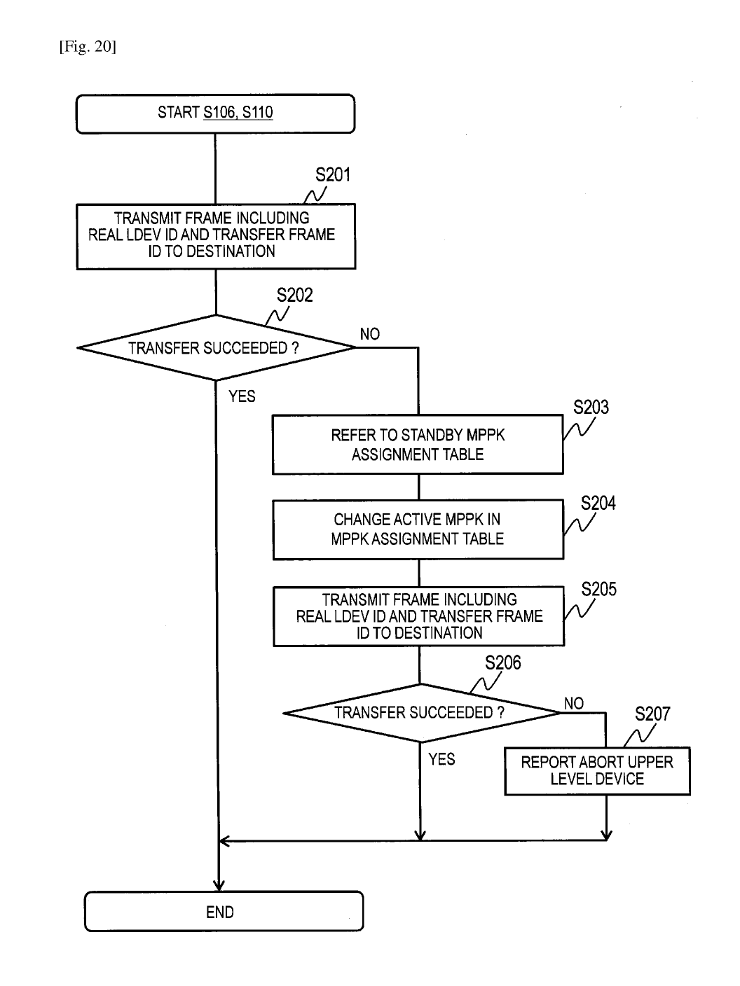

FIG. 19 is a flowchart illustrating exemplary processing by the GR 112 (such as GR 112AA, GR 112AB, and GR 112BA) that has received a frame. Upon receipt of data (a frame or a response), the GR 112 determines whether the received data is a frame including a command or a response to a frame (such as a notice of completion) (S101).

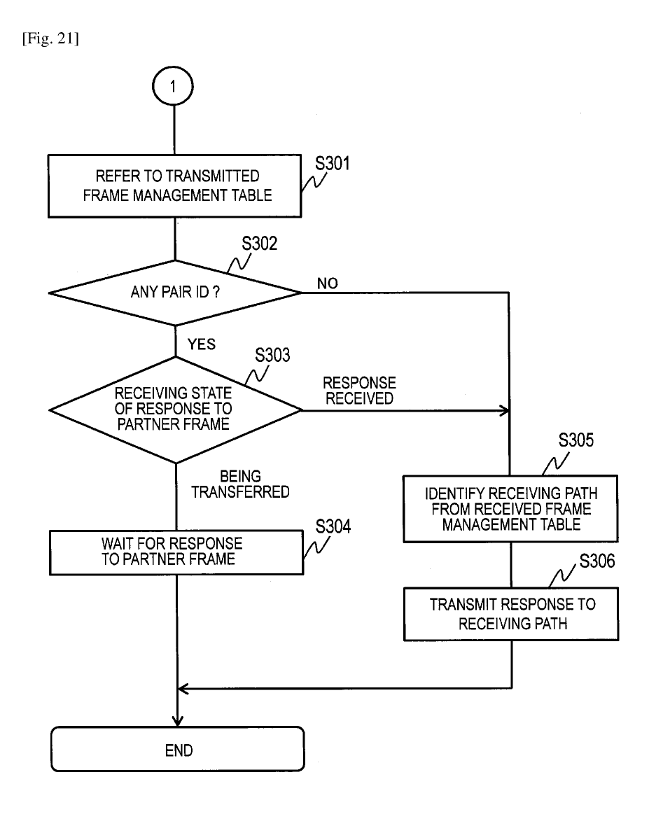

If the received data is a response (RESPONSE at S101), the GR 112 proceeds to the flowchart of FIG. 21 via the connector 1. This flowchart will be described later. If the received data is a frame including a command (CMD at S101), the GR 112 determines whether the frame is a frame received from the host computer 18 or a frame received from another CHA in the storage system (S102). For example, the frame has an identifier of the sender.

If the received frame is from the host computer 18 (YES at S102), the GR 112 acquires the virtual LDEV number corresponding to the LUN designated by the frame (S103). Next, the GR 112 acquires the real LDEV ID corresponding to the virtual LDEV number from the virtual LDEV management table (S104). Furthermore, the GR 112 locates the destination of the received command with reference to the virtual LDEV management table (S105).

The GR 112 transmits the received command (and further write data if the command is a write command) to the located destination (S106). The details of this step S106 will be described with reference to FIG. 20. If another real LDEV has been associated with the virtual LDEV number (NO at S107), the GR 112 returns to step S104.

If the frame has been transmitted to the command destinations of all the real LDEVs associated with the virtual LDEV number (YES at S107), the GR 112 registers new entries in the received frame management table and the transmitted frame management table (transfer frame management table) (S108).

At step S102, if the received frame is from another CHA (NO at S102), the GR 112 locates the destination of the received command with reference to the virtual LDEV management table (S109). The GR 112 transmits the frame including the received command (and further write data if the command is a write command) to the located destination (S110). The details of this step S110 will be described later with reference to FIG. 20.

Next, with reference to FIG. 20, details of steps S106 and S110 in the flowchart of FIG. 19 will be described. The GR 112 transmits the frame including a real LDEV ID and a transfer frame ID to the located destination (S201). Upon success of the transmission (transfer) of the frame (YES at S202), the GR exits this flow.

If the transfer is failed, for example, if the GR 112 cannot receive a response to the frame transmitted to the LR in the local CHA when a predetermined time has passed (NO at S202), the GR 112 proceeds to step S203. This operation can make proper determination that a failure occurs in the active MPPK without an additional process to determine the failure. At step S203, the GR 112 identifies the standby MPPK assigned to the real LDEV ID included in the frame failed in transfer with reference to the standby MPPK management table.

The GR 112 rewrites the value in the active MPPK cell of the entry including the foregoing real LDEV ID with the identified identifier of the standby MPPK in the MPPK assignment table referred to by the LR 113 in the local CHA (S204). The GR 112 transmits a frame including the foregoing real LDEV ID and the transfer frame ID again to the LR 113 in the local CHA (S205). The LR 113 in the local CHA transmits the frame to the replacement MPPK.

Upon receipt of a notice of completion from the replacement MPPK that has processed the command via the LR 113 (YES 206), the GR 112 exits this flow. If the GR 112 cannot receive a notice of completion from the replacement MPPK, either (NO at S206), it notifies an upper-level device, which is the sender of the frame, of an abort (S207). The upper-level device is the host computer 18, the other storage subsystem, or another CHA in the local storage subsystem.

Next, with reference to FIG. 21, exemplary processing by the GR 112 when it receives a response to a frame from another element in the storage system will be described. The GR 112 refers to the transmitted frame management table and identifies the entry including the transfer frame ID included in the received response (S301). After changing the value of the transfer state cell of the entry into “RESPONSE RECEIVED”, the GR determines whether the identified entry indicates a specific value for a pair ID (S302).

If a value is held for the pair ID (YES at S302), the GR 112 acquires the value in the transfer state cell of the entry including the identified pair ID (the entry of the partner frame) in the transmitted frame management table. If the value is “BEING TRANSFERRED” (BEING TRANSFERRED at S303), the GR 112 waits for a response to the partner frame (S304).

If the entry does not indicate a specific value for the pair ID at step S302 (NO at S302) or if the value in the transfer state cell is “RESPONSE RECEIVED” at step S303 (RESPONSE RECEIVED at S303), the GR 112 refers to the received frame management table and identifies the receiving path in the entry including the same transfer frame ID as the received response (S305). The GR 112 transmits a response to the identified receiving path (S306). If the entry in the received frame management table indicates a received frame ID, the response includes the received frame ID as a transfer frame ID.

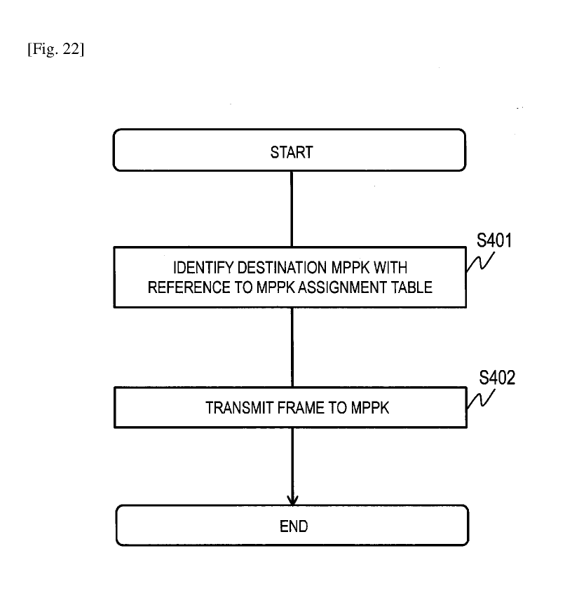

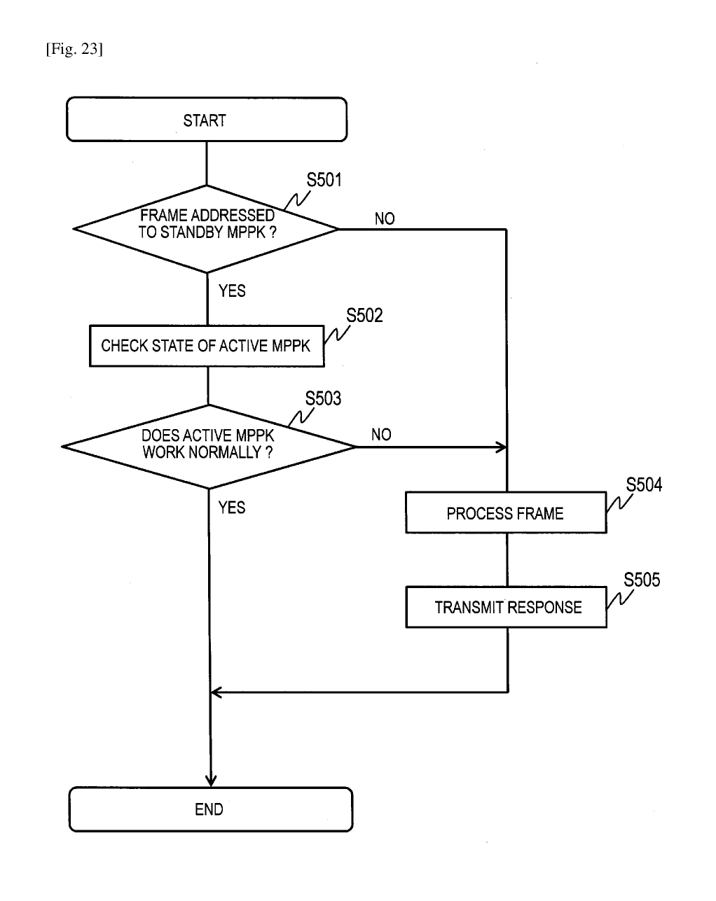

Next, with reference to the flowchart of FIG. 22, exemplary processing by the LR 113 will be described. Upon receipt of a frame, the LR 113 identifies the MPPK for the destination of the command with reference to the MPPK assignment table (S401). Specifically, the LR 113 acquires a value in the active MPPK cell of the entry which includes the real LDEV ID in the frame. The value is the identifier of the destination MPPK. The LR 113 transmits the frame to the identified MPPK (S402).

Next, with reference to the flowchart of FIG. 23, exemplary processing by an MP 132 (MPPK) that has received a frame will be described. The MP 132 determines whether the received frame is a frame addressed to an active MPPK or a standby MPPK (S501). For example, the MP 132 acquires the value of the real LDEV number from the received frame, refers to the standby MPPK assignment table, and acquires the identifiers of the active MPPK and the standby MPPK associated with the real LDEV number from the table. The frame may include information indicating whether the frame is a frame transmitted to an active MPPK.

If the identifier of the MP 132 corresponds to the acquired identifier of the standby MPPK, the MP 132 determines that the received frame is addressed to a standby MPPK; if its own identifier is the same as the acquired identifier of the active MPPK, it determines that the received frame is addressed to an active MPPK.

If the received frame is a frame addressed to an active MPPK (NO at S501), the MP 132 processes the received frame (S504) and returns a response (such as a notice of completion or read data) to the LR 113 (S505).

If the received frame is a frame addressed to a standby MPPK (YES at S501), the MP 132 checks the state of the active MPPK (S502). For example, the MP 132 may refer to the failure management table held in the control information memory 122 to check whether a failure occurs in the active MPPK or alternatively, transmit a signal for failure detection to the active MPPK to check whether a failure occurs.

If the active MPPK is not normal (a failure occurs in the active MPPK) (NO at S503), the MP 132 processes the received frame (S504) and transmits a response to the frame to the LR 113 (S505).

If the active MPPK is normal (YES at S503), the MP 132 exits this flow without processing the received frame because the active MPPK should respond to the LR 113. In this case, the GR 112 receives a response from the active MPPK after step S206 in the flowchart of FIG. 20.

If the active MPPK is normal, the MP 132 rewrites the value in the active MPPK cell in the MPPK assignment table for the LR 113 back to the identifier of the MPPK before the switch from its own identifier. Alternatively, the MP 132 notifies the LR 113 that the active MPPK is normal and the LR 113 or the GR 112 that has received the notice from the LR 113 rewrites the value in the foregoing active MPPK cell back to the original value.

As described above, the GRs for managing transfers of commands and responses thereto among a plurality of storage subsystems and the LRs for managing transfers in their local storage subsystems manage data transfers among the storage subsystems not via the MPs. A GR transfers a command toward the LRs in the both storage subsystems and the LR in each storage subsystem assigns the command to an MPPK. A MP in the MPPK assigned the command process the command. This configuration achieves low overhead and low load concentration to the MPPKs (MPs) in frame transfers.

The above-described example switches paths so as to transfer commands to a normal MPPK when a failure occurs in an active MPPK. This operation prevents command loss because of a failure in the MPPK and lowers the possibility of no response to the host.

As set forth above, an embodiment of this invention has been described; however, this invention is not limited to the foregoing embodiment. Those skilled in the art can easily modify, add, or convert each element in the foregoing embodiment within the scope of this invention. A part of the configuration of the embodiment can be added to, deleted from, or replaced with that of a different configuration.

A CPU, a microprocessor, or a group of microprocessors, which is a processor, operates in accordance with a program to perform predetermined processing. Accordingly, the explanations in the embodiments having the subjects of “processor” may be replaced with those having the subjects of “program”. The processing executed by a processor is processing performed by the apparatus or the system in which the processor is installed.

In the above-described embodiment, control information is expressed by a plurality of tables, but the control information used by this invention does not depend on data structure. The control information can be expressed by any data structure such as a database, a list, or a queue, other than a table. In the above-described embodiment, terms such as identifier, name, and ID can be replaced with one another.

The above-described configurations, functions, processors, and means for processing, for all or a part of them, may be implemented by, for example, hardware designed with integrated circuits. The information of programs, tables, and files to implement the functions may be stored in a storage device such as a non-volatile semiconductor memory, a hard disk drive, or an SSD, or a computer-readable non-transitory data storage medium such as an IC card, an SD card, or a DVD.

1. A storage system comprising:
a first storage subsystem providing a first volume; and
a second storage subsystem providing a second volume for storing copy data of data in the first volume,
wherein the first storage subsystem includes a first router, a first processor, and a second processor,
wherein the first router receives a first write command and first write data for the first write command from a host,
wherein the first router transfers the first write command and the first write data to the second storage subsystem,
wherein the second storage subsystem stores the first write data to the second volume in accordance with the first write command,
wherein the first processor is an active processor for processing the first write command,
wherein the second processor is a standby processor for processing the first write command,
wherein, upon determination that the first processor cannot process the first write command because of a failure, the first router transfers the first write command to the second processor, and
wherein the second processor performs processing to store the first write data to the first volume in accordance with the first write command.

2. A storage system according to claim 1,
wherein the first router includes a first global router for controlling transfers of write commands between the first storage subsystem and the second storage subsystem and a first local router for controlling transfers of write commands between the first global router and the first and the second processors, and
wherein the first global router transmits a notice of completion of processing the first write command to the host after acquisition of both of a first notice of completion of processing the first write command by the second processor and a second notice of completion of processing the first write command by the second storage subsystem.

3. A storage system according to claim 2,
wherein the first global router assigns a first identifier to the first write command to transfer the first write command to the first local router,
wherein the first global router assigns a second identifier to the first write command to transfer the first write command to the second storage subsystem,
wherein the first global router associates the first identifier with the second identifier to manage the first identifier and the second identifier, and
wherein the first global router transmits the notice of completion for the first write command to the host after acquisition of both of the first notice of completion assigned the first identifier and the second notice of completion assigned the second identifier.

4. A storage system according to claim 3,
wherein the first storage subsystem further includes a second router including a second global router and a second local router,
wherein the first global router transfers the first write command to the second storage subsystem via the second global router, and
wherein the second global router receives the first write command assigned the second identifier from the first global router and assigns a third identifier to the first write command to transfer the first write command to the second storage subsystem,
wherein the second global router associates the second identifier with the third identifier to manage the second identifier and the third identifier, and
wherein, upon receipt of the second notice of completion assigned the third identifier from the second storage subsystem, the second global router transmits the second notice of completion assigned the second identifier to the first global router.

5. A storage system according to claim 1,
wherein, in a case where the first router does not receive a notice of completion of processing the first write command by the first processor when a predetermined time has passed since the first router transferred the first write command to the first processor, the first router determines that the first processor cannot process the first write command because of a failure.

6. A control method for a storage system including a first storage subsystem including a first router, a first processor, and a second processor and providing a first volume, and a second storage subsystem providing a second volume for storing copy data of data in the first volume, the control method comprising:
receiving, by the first router, a first write command and first write data for the first write command from a host;
transferring, by the first router, the first write command and the first write data to the second storage subsystem;
storing, by the second storage subsystem, the first write data to the second volume in accordance with the first write command;
transferring, by the first router, the first write command to the second processor, which is a standby processor for processing the first write command, upon determination that the first processor cannot process the first write command because of a failure; and
performing, by the second processor, processing to store the first write data to the first volume in accordance with the first write command.

7. A control method for a storage system according to claim 6,
wherein the first router includes a first global router for controlling transfers of write commands between the first storage subsystem and the second storage subsystem and a first local router for controlling transfers of write commands between the first global router and the first and the second processors, and
wherein the control method further comprises transmitting, by the first global router, a notice of completion of processing the first write command to the host after acquisition of both of a first notice of completion of processing the first write command by the second processor and a second notice of completion of processing the first write command by the second storage subsystem.

8. A control method for a storage system according to claim 7, further comprising:
assigning, by the first global router, a first identifier to the first write command to transfer the first write command to the first local router;
assigning, by the first global router, a second identifier to the first write command to transfer the first write command to the second storage subsystem;
associating, by the first global router, the first identifier with the second identifier to manage the first identifier and the second identifier; and
transmitting, by the first global router, the notice of completion of processing the first write command to the host after acquisition of both of the first notice of completion assigned the first identifier and the second notice of completion assigned the second identifier.

9. A control method for a storage system according to claim 8,
wherein the first storage subsystem further includes a second router including a second global router and a second local router, and
wherein the control method further comprises:
transferring, by the first global router, the first write command to the second storage subsystem via the second global router;
receiving, by the second global router, the first write command assigned the second identifier from the first global router and assigning a third identifier to the first write command to transfer the first write command to the second storage subsystem;
associating, by the second global router, the second identifier with the third identifier to manage the second identifier and the third identifier; and
transmitting, by the second global router, the second notice of completion assigned the second identifier to the first global router upon receipt of the second notice of completion assigned the third identifier from the second storage subsystem.

10. A control method for a storage system according to claim 6, wherein, in a case where the first router does not receive a notice of completion of processing the first write command by the first processor when a predetermined time has passed since the first router transferred the first write command to the first processor, the first router determines that the first processor cannot process the first write command because of a failure.
